(19) United States
(12) Patent Application Publication
(10) Pub. No.: US 2012/0276273 A1
(43) Pub. Date: Nov. 1, 2012

(54) METHOD OF DETACHING A MUSCLE AND BEEF PRODUCTS PRODUCED BY THE METHOD

(76) Inventors: David R. McKenna, Benton, KS (US); Kyle Pfeiffer, Aledo, TX (US); Derek J. Vote, Valley Center, KS (US)

(21) Appl. No.: 13/504,392

(22) PCT Filed: Oct. 29, 2010
(86) PCT No.: PCT/US10/54820

§ 371 Date: Jul. 16, 2012

Related U.S. Application Data
(60) Provisional application No. 61/256,671, filed on Oct. 30, 2009.
(60) Provisional application No. 61/256,629, filed on Oct. 30, 2009.

(51) Int. Cl. A22C 17/00; A23L 1/31; A22C 15/00

(52) U.S. Cl. 426/645; 452/135

(57) ABSTRACT

Described is a method of detaching a muscle from a beef cattle carcass, the method comprising the steps of: locating the muscle comprising at least one attachment point to the beef cattle carcass; and detaching the attachment point of the muscle from the beef cattle carcass prior to the onset of rigor mortis. An assembly line method is also described. Also, described are muscles comprising a substantially symmetrical and cylindrical-shape. In addition, described are muscle beef products that are produced by the methods described herein.

### CROSS-REFERENCE TO RELATED APPLICATIONS

This application claims priority to U.S. Provisional Application Ser. No. 61/256,671, filed Oct. 30, 2009 and entitled “METHOD OF DETACHING A BEEF TRI-TIP MUSCLE AND BEEF PRODUCTS PRODUCED BY THE METHOD”, and U.S. Provisional Application Ser. No. 61/256,629, filed Oct. 30, 2009 and entitled “METHOD OF DETACHING A MUSCLE FROM AN ANIMAL CARCASS AND MEAT PRODUCTS PRODUCED BY THE METHOD” the entire contents of which are both incorporated herein by reference for all purposes.

### FIELD OF THE INVENTION

The invention relates generally to food processing, and particularly to processing of a beef cattle carcass. More particularly, the invention relates to a method of detaching a muscle from an animal carcass prior to the onset of rigor mortis. More particularly, the invention relates to a method of detaching a tri-tip muscle from a beef cattle carcass prior to rigor mortis, resulting in a generally symmetrical, cylindrically-shaped, tender tri-tip muscle being formed.

### BACKGROUND OF THE INVENTION

In a slaughter operation for beef cattle, the operation includes stunning, bleeding, and evisceration of the beef cattle. The beef cattle are also skinned. Subsequently, the resulting beef cattle carcasses may be cooled. During the operation, the beef cattle are generally suspended or hung upside down by one of their hind legs as they are moved along a processing line.

The onset of rigor mortis is characterized by stiffening and loss of extensibility of the muscles that occurs in animals shortly after death. Typically, rigor mortis occurs about twenty-four hours post mortem in beef cattle. The beef cattle carcass is generally cut after rigor mortis has occurred.

The term “beef cattle carcass” typically refers to both sides of the animal after slaughter, whereas a side refers to half of the carcass including both a frontquarter and a hindquarter. From the standpoint of profitability the hindquarter cuts of the carcass, which represents about half of a side of a beef carcass, traditionally have been greatest in demand. In particular, the hindquarter includes the M. tensor fasciae latae muscle, which is commonly referred to as the “tri-tip.”

The tri-tip is a non-symmetrically shaped muscle when attached to the carcass because of its anatomical attachment points. When beef cattle carcasses are suspended during the slaughter process, the tri-tip is even further stretched into an irregular, elongated triangular shape.

It is desirable to generate tender portions out of a piece of meat. Also, it is desirable to generate as many of portions (i.e., steaks and roasts) as possible. When cuts of meat are not symmetrically shaped, it is difficult to achieve maximal yield, or in order to achieve maximal yield it is necessary to compromise consistency in portion appearance, profile, thickness, fiber orientation, etc. A symmetrical or regular shape of a muscle is, therefore, desired rather than an irregular shape, since more cuts and cuts that are more consistent are possible from such a muscle. Also, any processing steps that provide tender meat are also desired.

### SUMMARY OF THE INVENTION

The invention is a method of detaching a muscle from an animal carcass prior to the onset of rigor mortis. An unexpected result of the invention is that by detaching the muscle while in a pre-rigor condition after slaughter, the shape of the muscle may be different from that resulting from post-rigor detachment. Preferably, the resulting muscle will have a generally symmetrical and cylindrical-shape. The shapes of certain muscles in an animal carcass may be affected by the carcass being hung, e.g., by a hind foot, and cut after the onset of rigor mortis. By severing an attachment point or more than one attachment point of the muscle to the remainder of the carcass before the onset of rigor mortis, the muscle may not be artificially stretched nor remain in that stretched shape. The result may be a generally symmetrical, cylindrically-shaped muscle or other more favorably shaped muscle.

One embodiment, and without limitation to the invention, is the method of detaching the M. tensor fasciae latae (tri-tip) muscle from a beef cattle carcass prior to the onset of rigor mortis. Unexpectedly by detaching the tri-tip while in a pre-rigor condition after slaughter, the shape of the tri-tip that results is generally symmetrical and cylindrically-shaped. The shape of the tri-tip, when detached after the onset of rigor mortis and after the carcass has been hung by a hind foot, is an irregular, elongated triangle shape. By severing an attachment point before the onset of rigor mortis, as in the invention, the tri-tip is not artificially stretched and does not persist in that stretched shape. The result is a generally symmetrical, cylindrically-shaped muscle.

Similarly, severing the biceps femoris (bottom round flat) or deep pectoral muscle after the onset of rigor mortis and after the carcass has been hung by the hind food is an irregularly shaped muscle. By severing the attached point before the onset of rigor mortis, as in the invention, the muscles are not artificially stretched and do not persist in that irregular, stretched shape.

As a result of the generally symmetrical and cylindrical-shape of the muscle, including the tri-tip, resulting from the invention, the muscle will have an enhanced per pound value. Thus, more desirable cuts of meat may arise from the symmetrical, cylindrically-shaped tri-tip than from an elongated, triangular-shaped tri-tip muscle that results from other prior methods of detachment.

A muscle maintains extensibility until the onset of rigor mortis. As such, when an origin or insertion point is severed on a pre-rigor muscle, there is a natural tendency for the muscle to change shape.

With respect to the tri-tip, because the M. tensor fasciae latae is in a stretched/extended state on a suspended (i.e., hung) carcass, there is a tendency of the muscle to shorten when detached. When a muscle shortens, the lengths of individual sarcomeres within the muscle fibers become shorter, which generally has a negative effect on tenderness. The skilled artisan would expect that a muscle that is detached from a carcass under pre-rigor conditions would be tougher than one that is detached post-rigor, for the reasons above. Surprisingly, the tri-tip meat portions that have been detached pre-rigor, in accordance with the invention, exhibit about the same tenderness value as tri-tips that have been detached post-rigor. In an embodiment of the present invention, the tenderness value of the pre-rigor detached tri-tip is about 30% lower than the “tender/tough” threshold as defined in a meat toughness measurement evaluation. For example, historical data by Belew et al., in Warner-Bratzler Shear Evaluations of 40 Bovine Muscles, Meat Science (2003) 507, 512, showed that “normal” tri-tips (i.e., detached post-rigor) are about 30% lower than the “tender/tough” threshold (with the “tender/tough” threshold for Warner-Bratzler being 4.6 kgf).

Likewise, tenderness testing, using a Slice-Shear methodology, has shown that the tenderness value of pre-rigor detached tri-tips is about 30% lower than the “tender/tough” threshold of 22 kilogram-force (kgf). Slice-Shear force values lower than 22 kgf are considered to be “tender,” whereas, Slice-Shear force values of greater than 22 kgf are considered to be “tough.” Therefore, even though it might be expected that pre-rigor detached tri-tips muscles would be tough, the tenderness of the tri-tips detached in accordance with the invention, is similar to “normal” tri-tips detached post-rigor.

FIGS. 1-3 include results from testing using the Slice-Shear methodology. FIG. 1 shows the Slice-Shear force values for tri-tips using blade tenderization, in accordance with the invention. FIG. 2 shows the Slice-Shear force values for tri-tips without blade tenderization. FIG. 3 shows the percentage of steaks from the pre-rigor detached tri-tips (with blade tenderization) that are classified as tender, i.e., meaning a Slice-Shear force value of less than 21.3 kgf.

Therefore, another unexpected result of the invention is that the tri-tip is surprisingly tender when detached according to the inventive method.

The invention provides a method of detaching a tri-tip muscle from a beef cattle carcass. In one embodiment, the invention comprises the steps of: locating the tri-tip muscle, wherein the tri-tip muscle comprises at least one attachment point to the beef cattle carcass; and detaching at least one attachment point of the tri-tip muscle from the beef cattle carcass prior to the onset of rigor mortis. The step of detaching may comprise cutting at least one attachment point. The attachment point may be a most distal point of attachment of the tri-tip to the remainder of the hindquarter, or an insertion point for the muscle. The method may further comprise a step of cooling the tri-tip muscle. The detached tri-tip may have a substantially symmetrical and cylindrical-shape.

The invention also provides an assembly line method of processing beef cattle carcasses that are hung for conveying on a process line, comprising the steps of: hanging a plurality of beef cattle carcasses; conveying the plurality of beef cattle carcasses along a process line; locating a tri-tip muscle in each beef cattle carcass, wherein the tri-tip muscle comprises at least one attachment point to the beef cattle carcass; and detaching at least one attachment point of the tri-tip muscle from each beef cattle carcass prior to the onset of rigor mortis.

In addition, the invention provides tri-tip muscle beef products produced by the method described herein. In particular, the beef product may be a tri-tip muscle detached from a beef cattle carcass comprising a shape that is substantially symmetrical and cylindrical. In addition, the tri-tip muscle beef product may be a part or portion of the tri-tip muscle.

### BRIEF DESCRIPTION OF THE DRAWINGS

The accompanying drawings, which are incorporated in and constitute a part of this application, illustrate several aspects of the invention and together with a description of the embodiments serve to explain the principles of the invention. A brief description of the drawings is as follows:

FIG. 1 is a graph showing Slice-Shear force values for tri-tips with blade tenderization;

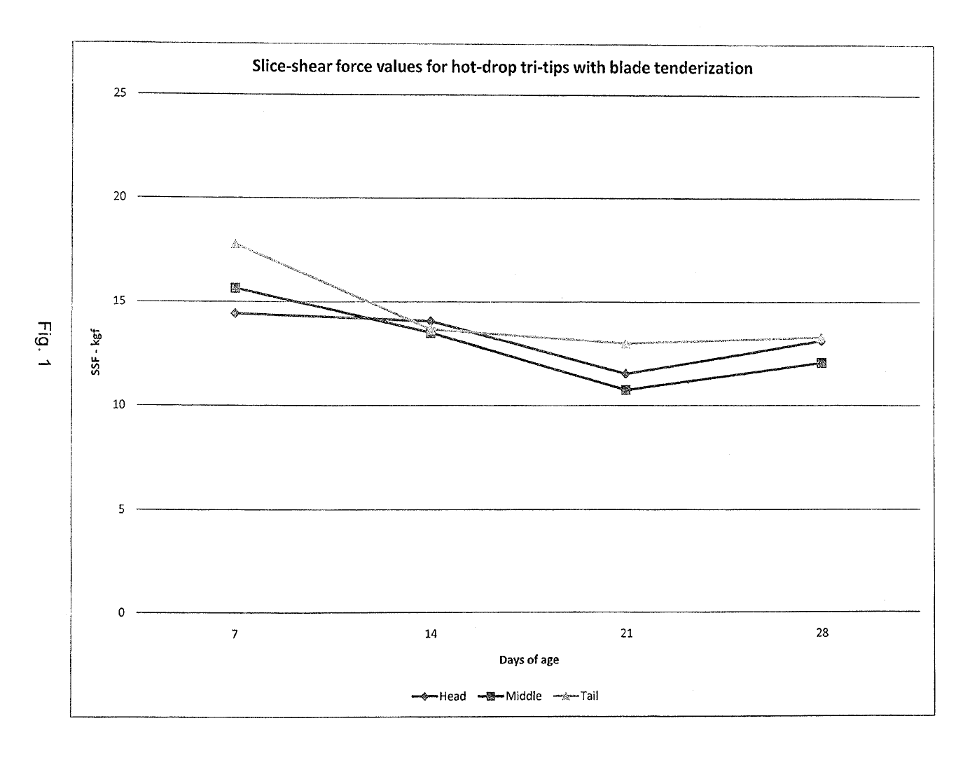

FIG. 2 is a graph showing Slice-Shear force values for tri-tips without blade tenderization;

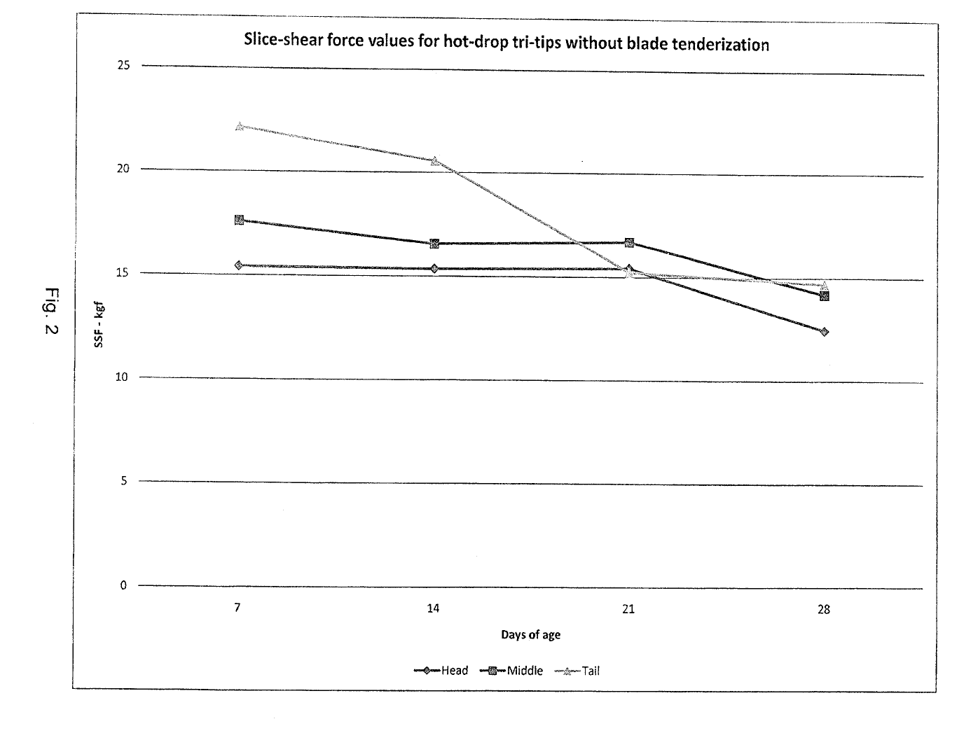

FIG. 3 is a graph showing the percentage of steaks from tri-tips that are classified as “tender” (having a Slice-Shear force value less than 21.3 kilogram-force (kgf));

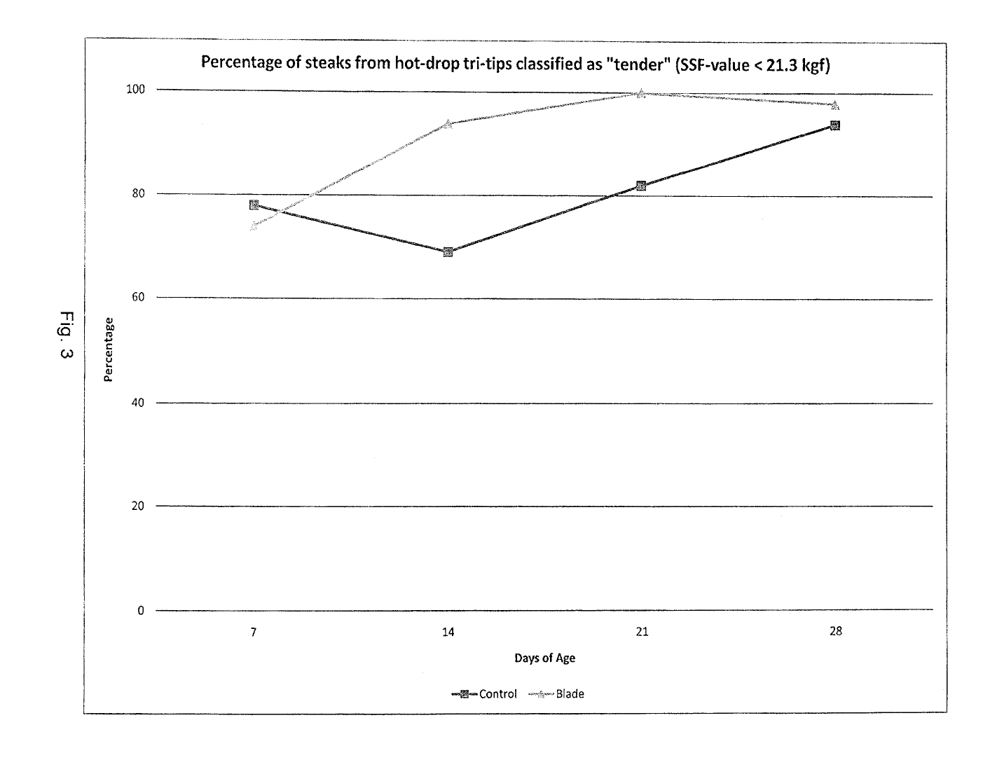

FIG. 4 is a photograph of a side of beef cattle carcass showing an outline of a tri-tip muscle and a preferred detachment point in accordance with the invention; and

FIG. 5 includes three photographs of tri-tip muscles, with the “Normal Tri-tip” photograph showing the shape that results from post-rigor detachment, the “Expected Tri-tip” photograph showing the shape that is expected to result from pre-rigor detachment, and the “Actual Tri-tip” photograph showing the unexpected generally symmetrical, cylindrical-shape of the tri-tip that results from pre-rigor detachment.

### DETAILED DESCRIPTION OF PREFERRED EMBODIMENTS

The embodiments of the invention described below are not intended to be exhaustive or to limit the invention to the precise forms disclosed in the following detailed description. Rather a purpose of the embodiments chosen and described is so that the appreciation and understanding by others skilled in the art of the principles and practices of the invention can be facilitated.

For purposes of this application, the terms “meat(s)” or “meat product(s)” or “cuts of meat” are synonymous and refer to the fresh cuts of meat offered to the wholesale and retail public. The term “carcass” refers to fresh, whole, meat-animal carcasses. The term “parts thereof” when referring to “carcass” refers to still-whole or disassembled parts of a meat-animal carcass, such as the conventional cuts or portions in which meat is packaged for sale to wholesalers, as well as the further cuts or portions into which meat is rendered for sale to consumers.

A method of processing a beef cattle carcass is provided by the invention. A beef cattle carcass generally refers to the body of such an animal after it has been stunned and rendered unconscious. The processing of a beef cattle carcass is generally an assembly line type operation where several carcasses are moved and processed along a series of stations. While the following may include a discussion of the processing of a single beef cattle carcass, it should be understood that the processing of the beef cattle carcass, according to the invention, can be applied to a continuous assembly line operation of processing numerous beef cattle carcasses. Preferably, such a continuous assembly line operation conveys anywhere from about 100 to greater than 300 beef cattle carcasses per hour.

In practice, the invention may be implemented after stunning, bleeding, and eviscerating the animal, and after skinning the carcass. The invention first comprises the step of identifying a muscle that has a distorted shape when the carcass is hung or suspended from a processing hanger, wherein the muscle comprises at least one attachment point to the animal carcass.

The animal carcass may be hung from a processing hanger by any portion thereof. Preferably, the animal carcass is hung by a hind foot, but other anatomical locations are also contemplated by the invention.

Preferably, the next step in the method is to detach at least one attachment point, while the carcass is in a pre-rigor condition. The most preferred attachment point or points will depend upon the particular animal and the particular muscle that is being detached.

With respect to the tri-tip, the invention first comprises the step of locating the tri-tip muscle in the beef cattle carcass. The tri-tip, or M. tensor fasciae latae, is a thin, broad rather triangular-shaped muscle on the lateral and cranial surface of the sirloin area and the cranial surface of the round. The origin of the muscle is the tuber coxae of the ilium. The muscle passes distally, ending in a sheet of fascia (fasciae latae). The fasciae latae extends to the region of the knee where it becomes continuous with the tendon of the biceps femoris, the border of the Sartorius muscle, and the tendon of the vastus lateralis. The result of the attachments is that the tensor fasciae latae has its insertion into the patella. The muscle serves to flex the hip joint and extends the stifle joint.

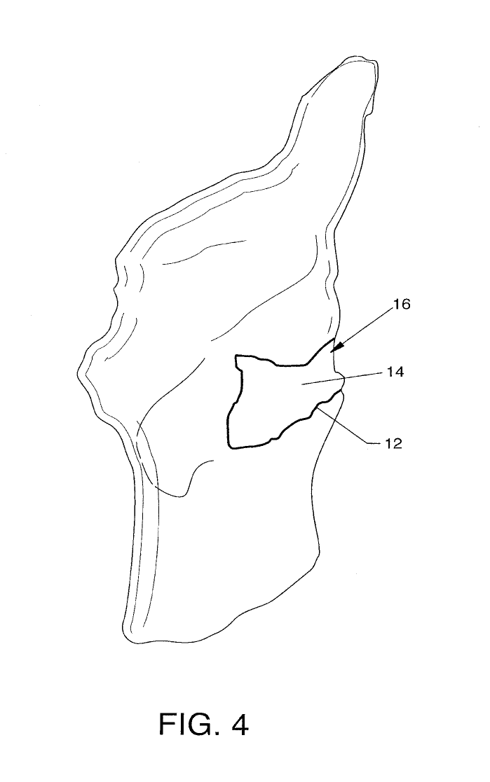

FIG. 4 shows a side of beef 10. A line 12 illustrates the outline of the tri-tip muscle 14. The tri-tip 14 comprises 2 attachment points. The attachment points are the origin (i.e., the tuber coxae of the ilium, basically the left vertical edge in FIG. 4 outline) and the insertion 16 (i.e., fasciae latae extending to the patella). The insertion attachment 16, is the preferred point of detachment of the inventive method. Alternatively, the muscle could be completely or partially detached at both the origin and insertion 16.

Preferably, the next step in the method is to detach at least one attachment point, preferably, attachment point 16, while the beef cattle carcass is in a pre-rigor condition.

The pre-rigor condition is characterized as the condition of the beef cattle carcass prior to the onset of rigor mortis, which is stiffening and loss of extensibility of the muscles that occurs in animals shortly after death. Typically, rigor mortis occurs about twenty-four hours post mortem in beef cattle.

Detaching the attachment point or points may be performed using a knife or some other cutting means. Alternatively, other suitable ways of detaching the attachment point or points from the remainder of the carcass (e.g., using ablation or lasers) are also contemplated and are not limited to those described herein. With respect to the tri-tip, detaching the tail attachment point may be performed using a knife or some other cutting means. Alternatively, other suitable ways of detaching the attachment point from the remainder of the carcass (e.g., using ablation or lasers) are also contemplated and are not limited to those described herein.

The result of the particular muscle being detached while the muscle is in a pre-rigor condition results in an unexpected, beneficial outcome. The detached muscle may be more tender than expected, and/or the muscle may have a more preferred shape for cutting into cuts of meat. Both benefits result in a higher per pound valve of the muscle.

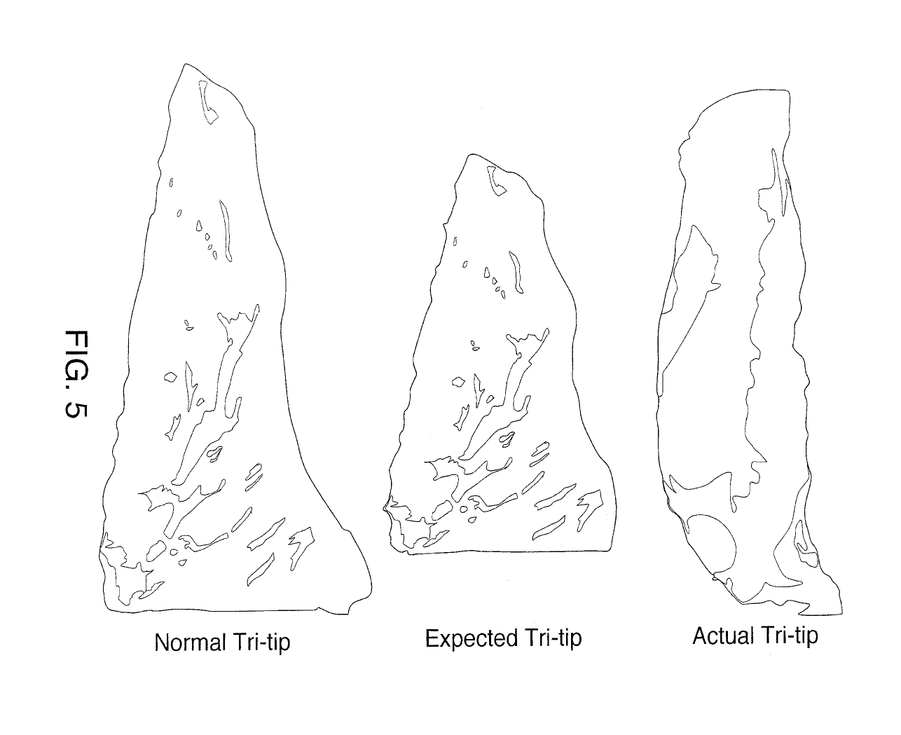

The result of the insertion attachment point 16 being detached while the tri-tip is in a pre-rigor condition results in an unexpected, beneficial outcome. The detached tri-tip forms a generally symmetrical, cylindrically-shaped muscle. FIG. 5 shows the generally symmetrical, cylindrical-shape in the “Actual Tri-tip” pictured. Detaching the tri-tip pre-rigor in the processing operation results in such a beneficial shape. The tri-tip is not artificially stretched by being hung and then undergoing rigor mortis prior to detachment, as shown in FIG. 5 in the photograph of the “Normal Tri-tip.” Also, the detached tri-tip does not form a triangular shape having a smaller size than that of the muscle while intact and not detached, which would be expected (as shown in FIG. 5 as the “Expected Tri-tip”). The symmetrical and cylindrical shape that results is beneficial because it is able to result in a high yield of desirable cuts from the muscle.

Another unexpected result of detaching the tri-tip prior to the onset of rigor mortis is that the muscle is quite tender. Usually when a muscle is detached it becomes tough. Contraction of a such a detached muscle is generally along the muscle fiber orientation, and usually results in a tough piece of meat. As a result of the inventive method, the resulting beef product, including the case where the beef product is the tri-tip, is quite tender.

The method of the invention may further comprise a step of cooling the muscle that is detached. Any suitable method of cooling the muscle is contemplated by the invention. The shape of the muscle preferably remains substantially the same after chilling as when the muscle was detached.

Additional steps in the inventive method of processing the trip-tip beef product are also contemplated by the invention, although not specifically provided herein.

The invention includes an assembly line method of processing beef cattle carcasses that are hung for conveying on a process line, comprising the steps of: hanging a plurality of beef cattle carcasses; conveying the plurality of beef cattle carcasses along a process line; locating a tri-tip muscle in each beef cattle carcass, wherein the tri-tip muscle comprises at least one attachment point to the beef cattle carcass; and detaching at least one attachment point of the tri-tip muscle from each beef cattle carcass prior to the onset of rigor mortis.

The invention also includes beef products produced by the methods described herein. In particular, the beef product may be a tri-tip muscle detached from a beef cattle carcass comprising a shape that is substantially symmetrical and cylindrical.

All patents, patent applications (including provisional applications), and publications cited herein are incorporated by reference as if individually incorporated for all purposes. Unless otherwise indicated, all parts and percentages are by weight and all molecular weights are weight average molecular weights. The foregoing detailed description has been given for clarity of understanding only. No unnecessary limitations are to be understood there from. The invention is not limited to the exact details shown and described, for variations obvious to one skilled in the art will be included within the invention defined by the claims.

1. A method of detaching a muscle from an animal carcass, the method comprising the steps of:
identifying a muscle that has a distorted shape when the carcass is hung from a processing hanger, wherein the muscle comprises at least one attachment point to the animal carcass; and
detaching at least one attachment point of the muscle from the animal carcass prior to the onset of rigor mortis.

2. The method of claim 1, wherein the step of detaching comprises cutting at least one attachment point.

3. The method of claim 1, further comprising a step of cooling the muscle.

4. The method of claim 1, wherein the detached muscle has a substantially relaxed configuration.

5. The method of claim 1, wherein the detached muscle has a substantially symmetrical and cylindrical shape.

6. The method of claim 1, wherein the carcass is hung from a hind foot of the carcass.

7. An assembly line method of processing animal carcasses that are hung for conveying on a process line, comprising the steps of:
hanging a plurality of animal carcasses;
conveying the plurality of animal carcasses along a process line;
identifying a muscle that has a distorted shape in each carcass when the carcass is hung from a processing hanger, wherein the muscle comprises at least one attachment point to the animal carcass; and
detaching at least one attachment point of the muscle from each animal carcass prior to the onset of rigor mortis.

8. A muscle detached from an animal carcass under pre-rigor conditions comprising a shape that is substantially symmetrical and cylindrical.

9. A meat product that is produced by the method of claim 1.

10. A meat product that is produced by the method of claim 7.

11. A method of detaching a tri-tip muscle from a beef cattle carcass, the method comprising the steps of:
locating the tri-tip muscle, wherein the tri-tip muscle comprises at least one attachment point to the beef cattle carcass; and
detaching at least one attachment point of the tri-tip muscle from the beef cattle carcass prior to the onset of rigor mortis.

12. The method of claim 11, wherein the step of detaching comprises cutting at least one attachment point.

13. The method of claim 11, wherein the attachment point is an insertion attachment of the tri-tip to the remainder of the hindquarter.

14. The method of claim 11, further comprising a step of cooling the tri-tip muscle.

15. The method of claim 11, wherein the detached tri-tip has a substantially symmetrical and cylindrical shape.

16. An assembly line method of processing beef cattle carcasses that are hung for conveying on a process line, comprising the steps of:
hanging a plurality of beef cattle carcasses;
conveying the plurality of beef cattle carcasses along a process line;
locating a tri-tip muscle in each beef cattle carcass, wherein the tri-tip muscle comprises at least one attachment point to the beef cattle carcass; and
detaching at least one attachment point of the tri-tip muscle from each beef cattle carcass prior to the onset of rigor mortis.

17. A tri-tip muscle detached from a beef cattle carcass comprising a shape that is substantially symmetrical and cylindrical.

18. A tri-tip muscle beef product that is produced by the method of claim 11.

19. A tri-tip muscle beef product that is produced by the method of claim 16.
